(19) United States
(12) Patent Application Publication
(10) Pub. No.: US 2024/0078483 A1
(43) Pub. Date: Mar. 7, 2024

(54) INFORMATION PROCESSING APPARATUS AND METHOD

(71) Applicant: TOYOTA JIDOSHA KABUSHIKI KAISHA, Toyota-shi (JP)

(72) Inventors: Mitsuhiro MIURA, Nagoya-shi (JP); Kenichi YAMADA, Nisshin-shi (JP); Satoshi KOMAMINE, Nagoya-shi (JP); Fumiyuki KAGARA, Sagamihara-shi (JP); Go TANAKA, Toyota-shi (JP); Hiroyuki NISHIZAWA, Itabashi-ku (JP)

(73) Assignee: TOYOTA JIDOSHA KABUSHIKI KAISHA, Toyota-shi (JP)

(21) Appl. No.: 18/460,851

(22) Filed: Sep. 5, 2023

(30) Foreign Application Priority Data
Sep. 5, 2022 (JP) 2022-141018

(51) Int. Cl. G06Q 10/0631; G06Q 10/02; G06Q 50/30

(52) U.S. Cl. CPC G06Q 10/06312; G06Q 10/02; G06Q 50/30

(57) ABSTRACT

An information processing apparatus includes a controller that acquires information about an article to be loaded onto a vehicle, acquires a characteristic of a person who can affect the article based on the information, and executes a concurrent riding determination to determine existence of concurrent riding on the vehicle by the article and a user having the characteristic.

### CROSS-REFERENCE TO RELATED APPLICATION

This application claims priority to Japanese Patent Application No. 2022-141018 filed on Sep. 5, 2022, the entire contents of which are incorporated herein by reference.

### TECHNICAL FIELD

The present disclosure relates to an information processing apparatus and a method.

### BACKGROUND

Technology related to cargo/passenger mixing is known. For example, Patent Literature (PTL) 1 discloses an information processing apparatus that manages operations of vehicles with loading space for cargo.

### CITATION LIST

### Patent Literature

PTL 1: JP 2020-149576 A

### SUMMARY

The user of a vehicle in which cargo and passengers are mixed could have an effect, particularly an undesirable effect, on articles loaded onto the vehicle. For example, in a case in which the articles loaded onto the vehicle are odor-sensitive articles (such as articles that come in contact with human skin), the articles may be affected and product quality may be degraded if a user who smoked before boarding the vehicle rides in the vehicle together with the articles. This is an unwanted consequence not only for the manufacturer of the product, but also for the user. However, if the user is not aware of this fact, it is difficult to take measures or to respond. Also, in a case in which a user who is to load articles onto a vehicle is waiting for a vehicle on which a user who could have an undesirable effect on articles is riding, the waiting user cannot easily take measures, such as loading the articles onto a different vehicle, unless information indicating the situation is provided.

In this way, conventional technology does not take into account the effect on articles from passengers when articles are transported in a mixed cargo/passenger load and thus has room for improvement.

It would be helpful to improve technology related to cargo/passenger mixing.

An information processing apparatus according to an embodiment of the present disclosure is an information processing apparatus including a controller configured to:
acquire information about an article to be loaded onto a vehicle;
acquire a characteristic of a person who can affect the article based on the information; and
execute a concurrent riding determination to determine existence of concurrent riding on the vehicle by the article and a user having the characteristic.

A method according to an embodiment of the present disclosure is a method to be executed by an information processing apparatus and includes:
acquiring information about an article to be loaded onto a vehicle;
acquiring a characteristic of a person who can affect the article based on the information; and
executing a concurrent riding determination to determine existence of concurrent riding on the vehicle by the article and a user having the characteristic.

According to an embodiment of the present disclosure, technology related to cargo/passenger mixing is improved.

### BRIEF DESCRIPTION OF THE DRAWINGS

FIG. 1 is a diagram illustrating a schematic configuration of a system according to an embodiment of the present disclosure;

FIG. 2 is a block diagram of a system according to the present embodiment;

FIG. 3 is a diagram illustrating an example of an operation plan;

FIG. 4 is a diagram illustrating an example of a user database;

FIG. 5 is a diagram illustrating an example of an article database;

FIG. 6 is a diagram illustrating an example of article transportation information;

FIG. 7 is a flowchart illustrating operations of the information processing apparatus according to the present embodiment; and

FIG. 8 is a flowchart illustrating the processing procedures for presenting a predetermined notification regarding cargo/passenger mixing.

### DETAILED DESCRIPTION

Hereinafter, an embodiment of the present disclosure will be described.

<Outline of Embodiment>

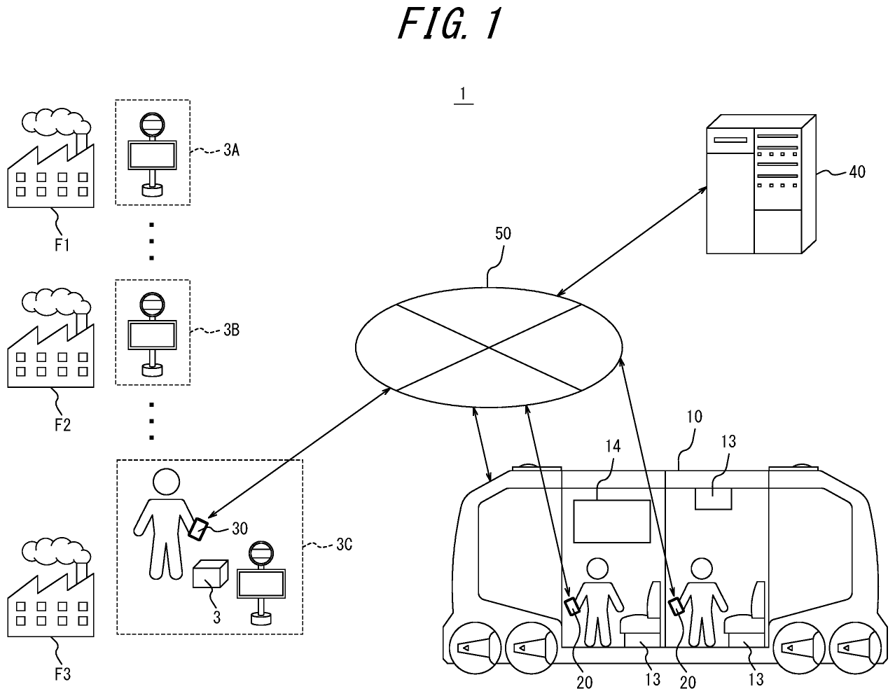

An outline of a system 1 according to an embodiment of the present disclosure will be described with reference to FIG. 1. The system 1 includes a vehicle 10, a first terminal apparatus 20, a second terminal apparatus 30, and an information processing apparatus 40. The vehicle 10, the first terminal apparatus 20, the second terminal apparatus 30, and the information processing apparatus 40 are communicably connected to a network 50 including, for example, the Internet, a mobile communication network, and the like.

The vehicle 10 is an automobile, for example, but is not limited to this, and may be any appropriate vehicle. The automobile is any type of automobile, such as a gasoline vehicle, a diesel vehicle, a hydrogen vehicle, a hybrid electric vehicle (HEV), a plug-in hybrid electric vehicle (PHEV), a battery electric vehicle (BEV), or a fuel cell electric vehicle (FCEV). The vehicle 10 is an autonomous vehicle in the present embodiment but may be driven by a driver. An autonomous vehicle is a vehicle whose operation is automated at any given level. The level of automation is, for example, one of level 1 to level 5 according to the classification of the Society of Automotive Engineers (SAE). The vehicle 10 may be a dedicated Mobility as a Service (MaaS) vehicle. In the present embodiment, the vehicle 10 travels within a predetermined site. However, the vehicle 10 may travel anywhere other than the site. The vehicle 10 departs from a vehicle base according to a timetable (operation schedule), in which the arrival and departure times for each stop are specified, and returns to the vehicle base after implementing mixed transportation of cargo and passengers while circulating along a predetermined route within the site. The route circulated by the vehicle 10 may include at least one stop and includes stop 3A, stop 3B, and stop 3C in the present embodiment. Stop 3A, stop 3B, and stop 3C can be the nearest stops to a first factory F1, a second factory F2, and a third factory F3, respectively. The number of vehicles 10 included in the system 1 may be freely determined.

The first terminal apparatus 20 is carried and used by a user of the vehicle 10. The first terminal apparatus 20 is, for example, a general purpose electronic device, such as a smartphone, a tablet, or a personal computer (PC). By operating the first terminal apparatus 20, the user of the vehicle 10 can confirm the predetermined notification regarding cargo/passenger mixing presented by the information processing apparatus 40 and transmit a response to the information processing apparatus 40 as necessary.

The second terminal apparatus 30 is carried and used by a user of the vehicle 10 who carries the article 3 onto the vehicle 10 (hereinafter also referred to as “transporting user”). The second terminal apparatus 30 is, for example, a general purpose electronic device such as a smartphone, a tablet, or a PC.

The transporting user, i.e., the user of the second terminal apparatus 30, boards the vehicle 10 together with the article 3 at the point of departure, places the article 3 on a seat or cargo rack, and alights from the vehicle 10 with the article 3 at the destination. By operating the second terminal apparatus 30, the transporting user can confirm the predetermined notification regarding cargo/passenger mixing presented by the information processing apparatus 40 and transmit a response to the information processing apparatus 40 as necessary. Although the transporting user corresponds to a transporting user in relation to the article the transporting user is carrying, the transporting user is simply one user of the vehicle 10 in relation to articles being carried by other transporting users and is therefore subject to the concurrent riding determination, described below, just like other users. An embodiment may also be implemented in which the transporting user alights from the vehicle after placing the article 3 on a predetermined cargo rack, and a user in charge of receipt at the destination receives the article by unloading it from the vehicle 10.

The transporting user may also transmit a notification (hereinafter also referred to as “first notification”) to the information processing apparatus 40 by operating the second terminal apparatus 30 to report that the article 3 has been loaded onto the vehicle 10. The transporting user may transmit a notification (hereinafter also referred to as “second notification”) to the information processing apparatus 40 by operating the second terminal apparatus 30 to report that the article 3 has been unloaded from the vehicle 10 and delivered to the delivery destination. This enables the information processing apparatus 40 to learn that the article 3 has been loaded and unloaded. The first and second notifications are transmitted from the second terminal apparatus 30 of one transporting user in the present embodiment, but this configuration is not limiting. For example, at least one of the notifications may be transmitted from a device of the administrator of the article 3 or from an external server. In an embodiment in which the transporting user places the article 3 on a predetermined cargo rack and then alights from the vehicle, and the user in charge of receipt at the destination unloads the article 3 from the vehicle 10 to receive the article 3, the first notification may be transmitted by the transporting user, and the second notification may be transmitted by the user in charge of receipt. The information processing apparatus 40 may also learn the location of the article 3 by way of a position transmitting apparatus attached to the article 3.

After the second notification is received from the second terminal apparatus 30, and the transporting user holding the second terminal apparatus delivers the article 3 to the delivery destination, the transporting user may use the vehicle 10 without transporting another article. In this case, it is realistic and appropriate to treat the transporting user as a user of the vehicle 10, i.e., a user of the first terminal apparatus 20, rather than as a transporting user. Therefore, in the present embodiment, the information processing apparatus 40 switches the treatment of the transporting user's terminal apparatus in a case in which it is determined that the article 3 has arrived at the destination based on the positional information of the second terminal apparatus 30 and the positional information of the vehicle 10, or in a case in which the second notification is received. Alternatively, in an embodiment in which the transporting user places the article 3 on a predetermined cargo rack and then alights from the vehicle, and the user in charge of receipt at the destination unloads the article 3 from the vehicle 10 to receive the article 3, the treatment of the transporting user's terminal apparatus may be switched in a case in which the first notification is received. Specifically, the controller 43 removes a transporting user designation of the corresponding transporting user in the user database (described below). This enables the controller 43 to treat the transporting user as a user of the vehicle 10 rather than a transporting user, and to treat the terminal apparatus carried by the user as the first terminal apparatus 20 rather than the second terminal apparatus 30. In other words, from the perspective of the information processing apparatus 40, it is easier to optimize the transmission and receipt of predetermined notifications by switching, in a timely manner, between treating the user's terminal apparatus as the first terminal apparatus 20 or the second terminal apparatus 30.

In this way, the second terminal apparatus 30 in the present embodiment can be the first terminal apparatus 20 depending on the delivery status of the article 3.

The information processing apparatus 40 is, for example, a computer such as a server. The information processing apparatus 40 can communicate with the vehicle 10, the first terminal apparatus 20, and the second terminal apparatus 30 via the network 50. In the present embodiment, the information processing apparatus 40 manages the operation of the vehicle 10, i.e., cargo/passenger mixing. The information processing apparatus 40 can also present information about cargo/passenger mixing to users of the vehicle 10, including the transporting user, by controlling the first terminal apparatus 20 or the second terminal apparatus 30 via the network 50 to transmit and output a predetermined notification about cargo/passenger mixing. By receiving the first notification or the second notification from the second terminal apparatus 30, the information processing apparatus 40 can learn that the article 3 has been loaded or unloaded and can switch, in a timely manner, between treating the user's terminal apparatus as the first terminal apparatus 20 or the second terminal apparatus 30.

First, an outline of the present embodiment will be described, and details thereof will be described later. The information processing apparatus 40 acquires information about the article 3 to be loaded onto the vehicle 10. The information processing apparatus 40 acquires a characteristic of a person who can affect the article 3 based on the information. The information processing apparatus 40 executes a concurrent riding determination to determine the existence of concurrent riding on the vehicle 10 by the article 3 and a user having the characteristic. The term “existence of concurrent riding” refers to whether the article 3 and a user having a characteristic of a person who can affect the article 3 (hereinafter also referred to as “NG (no good) user”) are concurrently riding in the vehicle 10, whether the article 3 and an NG user are expected to ride concurrently in the vehicle 10, or both. In other words, the concurrent riding determination in the present embodiment is for determining not only whether concurrent riding is actually occurring, but also whether concurrent riding could occur in the future.

According to the present embodiment, the existence of concurrent riding on the vehicle 10 by an article 3 and a user having a characteristic of a person who can affect the article 3 is thus determined by the concurrent riding determination. It is determined, by the concurrent riding determination, whether a user of the vehicle 10, including the transporting user, corresponds to a user having a characteristic of a person who can affect the article 3 that has been loaded, or is scheduled to be loaded, on the vehicle 10. Hence, in a case in which a user is determined to be a user having a characteristic of a person who can affect the article 3, it is easier to take measures or actions to reduce the effect of the NG user on the article 3 by presenting this fact to the user or the transporting user. Technology related to cargo/passenger mixing is therefore improved in that the effect on the article 3 from passengers is more easily reduced.

Next, configurations of the system 1 will be described in detail.

<Configuration of Vehicle>

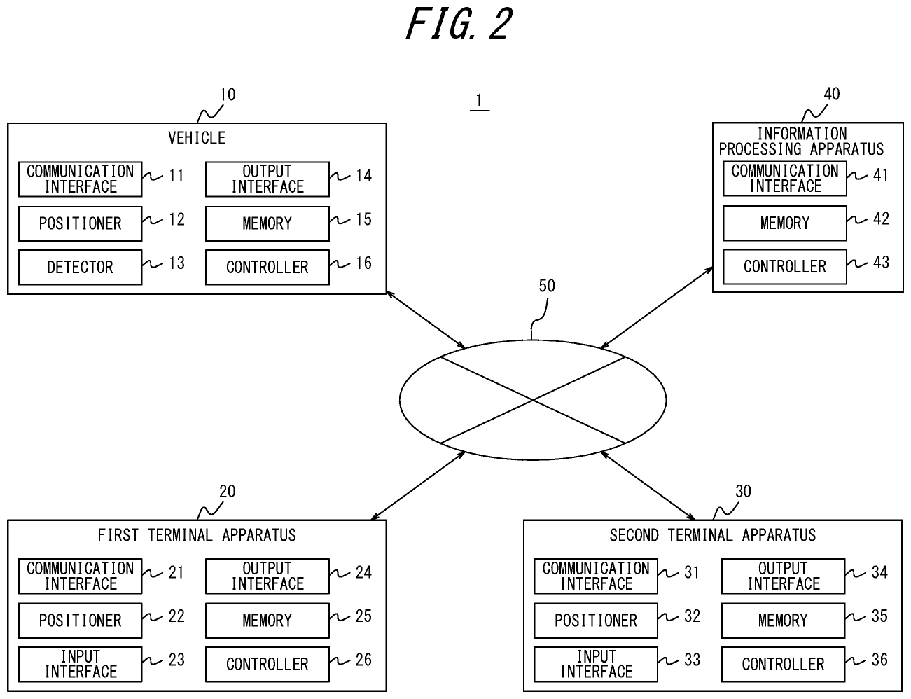

As illustrated in FIG. 2, the vehicle 10 includes a communication interface 11, a positioner 12, a detector 13, an output interface 14, a memory 15, and a controller 16.

The communication interface 11 includes at least one interface for communication for connecting to the network 50. The interface for communication is compliant with mobile communication standards such as the 4th generation (4G) standard or the 5th generation (5G) standard, for example, but these examples are not limiting. For example, the interface for communication may include an interface compliant with a short-range wireless communication standard such as Bluetooth® (Bluetooth is a registered trademark in Japan, other countries, or both) or Wi-Fi® (Wifi is a registered trademark in Japan, other countries, or both). In the present embodiment, the vehicle 10 communicates with the information processing apparatus 40 via the communication interface 11 and the network 50. The vehicle 10 may communicate with the first terminal apparatus 20, the second terminal apparatus 30, or both via the communication interface 11 and the network 50.

The positioner 12 includes one or more apparatuses configured to acquire positional information for the vehicle 10. Specifically, the positioner 12 includes a receiver compliant with the Global Positioning System (GPS), for example, but is not limited to this and may include a receiver compliant with any appropriate satellite positioning system.

The detector 13 includes any sensor module capable of acquiring information indicating the state of the vehicle 10. For example, the sensor module may include a vibration sensor, an infrared sensor, a speed sensor, an angular velocity sensor, an acceleration sensor, a geomagnetic sensor, a distance sensor such as LiDAR (light detection and ranging), an odor sensor, a dust sensor, or combinations of these.

The output interface 14 may include at least one output device for outputting information to notify the user of the information. The output device is a device such as a display for outputting information as images or video, a speaker for outputting information as audio, or the like, for example, but is not limited to these. The display is, for example, a liquid crystal display (LCD) or an organic electro luminescent (EL) display. The output interface 14 may include an interface for connecting to an external output device.

The memory 15 includes one or more memories. The memories are semiconductor memories, magnetic memories, optical memories, or the like, for example, but are not limited to these. The memories included in the memory 15 may each function as, for example, a main memory, an auxiliary memory, or a cache memory. The memory 15 stores any information used for operations of the vehicle 10. For example, the memory 15 may store a system program, an application program, embedded software, map information, and the like. The information stored in the memory 15 may be updated with, for example, information acquired from the network 50 via the communication interface 11. The memory 15 may store any information obtained by operations of the vehicle 10.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The vehicle 10 controls overall operations of the vehicle 10 autonomously using the controller 16 or according to instructions received from the information processing apparatus 40.

The controller 16 acquires positional information for the vehicle 10 via the positioner 12. The controller 16 transmits the acquired positional information for the vehicle 10 to the information processing apparatus 40 via the communication interface 11 and the network 50. The controller 16 may acquire, at predetermined time intervals, the positional information for the vehicle 10 and transmit the acquired positional information for the vehicle 10 to the information processing apparatus 40. The predetermined time intervals may be freely set but may also, for example, be based on the average speed of the vehicle 10. The controller 16 also acquires information about the interior of the vehicle 10 (odor, dust, or the like) by the detector 13. The controller 16 may transmit the acquired information about the interior of the vehicle 10 to the information processing apparatus 40 via the communication interface 11 and the network 50.

<Configuration of First Terminal Apparatus>

As illustrated in FIG. 2, the first terminal apparatus 20 includes a communication interface 21, a positioner 22, an input interface 23, an output interface 24, a memory 25, and a controller 26.

The communication interface 21 includes at least one interface for communication for connecting to the network 50. The interface for communication is compliant with a mobile communication standard such as 4G or 5G, for example, but is not limited to these. For example, the interface for communication may include an interface compliant with a short-range wireless communication standard such as Bluetooth® or Wi-Fi®. In the present embodiment, the first terminal apparatus 20 communicates with the information processing apparatus 40 via the communication interface 21 and the network 50. The first terminal apparatus 20 may communicate with the vehicle 10 or the second terminal apparatus 30, or with both of these, via the communication interface 21 and the network 50.

The positioner 22 includes at least one device for acquiring positional information for the first terminal apparatus 20. Specifically, the positioner 22 includes, for example, a receiver compliant with GPS but is not limited to this example and may include a receiver compliant with any appropriate satellite positioning system.

The input interface 23 includes at least one interface for input. The interface for input is, for example, a physical key, a capacitive key, a pointing device, or a touch screen integrally provided with a display. The input interface 23 accepts operations for inputting data to be used for the operations of the first terminal apparatus 20. The input interface 23, instead of being included in the first terminal apparatus 20, may be connected to the first terminal apparatus 20 as an external input device. As an interface for connection, for example, an interface compliant with a standard such as Universal Serial Bus (USB), High-Definition Multimedia Interface (HDMI®) (HDMI is a registered trademark in Japan, other countries, or both), or Bluetooth® can be used.

The output interface 24 may include at least one output device for outputting information to notify the user of the information. The output device is a device such as a display for outputting information as images or video, a speaker for outputting information as audio, or the like, for example, but is not limited to these. The display is, for example, an LCD or an organic EL display. The output interface 24 may include an interface for connecting to an external output device.

The memory 25 includes one or more memories. The memories are semiconductor memories, magnetic memories, optical memories, or the like, for example, but are not limited to these. The memories included in the memory 25 may each function as, for example, a main memory, an auxiliary memory, or a cache memory. The memory 25 stores any information used for operations of the first terminal apparatus 20. For example, the memory 25 may store a system program, an application program, embedded software, map information, or the like. The information stored in the memory 25 may be updated with, for example, information acquired from the network 50 via the communication interface 21. The memory 25 stores any information obtained by operations of the first terminal apparatus 20.

The controller 26 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 26 controls operations of the entire first terminal apparatus 20.

The controller 26 acquires positional information for the first terminal apparatus 20 via the positioner 22. The controller 26 transmits, to the information processing apparatus 40 via the communication interface 21 and the network 50, the acquired positional information for the first terminal apparatus 20, together with user identification information on the user of the first terminal apparatus 20 (hereinafter also referred to as “user ID”). The user ID is any information that can uniquely identify the user (for example, a user account). The controller 26 may acquire, at predetermined time intervals, the positional information for the first terminal apparatus 20 and transmit the acquired positional information for the first terminal apparatus 20, together with the user ID, to the information processing apparatus 40. The predetermined time intervals may be freely set but may also, for example, be based on the average speed at which the first terminal apparatus 20 moves.

<Configuration of Second Terminal Apparatus>

As illustrated in FIG. 2, the second terminal apparatus 30 includes a communication interface 31, a positioner 32, an input interface 33, an output interface 34, a memory 35, and a controller 36.

The communication interface 31 includes at least one interface for communication for connecting to the network 50. The interface for communication is compliant with a mobile communication standard such as 4G or 5G, for example, but is not limited to these. For example, the interface for communication may include an interface compliant with a short-range wireless communication standard such as Bluetooth® or Wi-Fi®. In the present embodiment, the second terminal apparatus 30 communicates with the information processing apparatus 40 via the communication interface 31 and the network 50. The second terminal apparatus 30 may communicate with the vehicle 10 or the first terminal apparatus 20, or with both of these, via the communication interface 31 and the network 50.

The positioner 32 includes at least one device for acquiring positional information for the second terminal apparatus 30. Specifically, the positioner 32 includes, for example, a receiver compliant with GPS, but is not limited to this example and may include a receiver compliant with any appropriate satellite positioning system. In the present embodiment, it is assumed that the transporting user holding the second terminal apparatus 30 moves together with the article 3. In this case, the position indicated by the positional information for the second terminal apparatus 30 can be considered as the position of the article 3.

The input interface 33 includes at least one interface for input. The interface for input is, for example, a physical key, a capacitive key, a pointing device, or a touch screen integrally provided with a display. The input interface 33 accepts operations for inputting data to be used for the operations of the second terminal apparatus 30. The input interface 33, instead of being included in the second terminal apparatus 30, may be connected to the second terminal apparatus 30 as an external input device. As an interface for connection, for example, an interface compliant with a standard such as USB, HDMI®, or Bluetooth®can be used.

The output interface 34 may include at least one output device for outputting information to notify the user of the information. The output device is a device such as a display for outputting information as images or video, a speaker for outputting information as audio, or the like, for example, but is not limited to these. The display is, for example, an LCD or an organic EL display. The output interface 34 may include an interface for connecting to an external output device.

The memory 35 includes one or more memories. The memories are semiconductor memories, magnetic memories, optical memories, or the like, for example, but are not limited to these. The memories included in the memory 35 may each function as, for example, a main memory, an auxiliary memory, or a cache memory. The memory 35 stores any information used for operations of the second terminal apparatus 30. For example, the memory 35 may store a system program, an application program, embedded software, map information, or the like. The information stored in the memory 35 may be updated with, for example, information acquired from the network 50 via the communication interface 31. The memory 35 stores any information obtained by operations of the second terminal apparatus 30.

The controller 36 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 36 controls operations of the entire second terminal apparatus 30.

In the present embodiment, the controller 36 acquires positional information for the second terminal apparatus 30 via the positioner 32. The controller 36 transmits, to the information processing apparatus 40 via the communication interface 31 and the network 50, the acquired positional information for the second terminal apparatus 30, together with the user ID of the user of the second terminal apparatus 30. The user ID is any information that can uniquely identify the user (for example, a user account). The controller 36 may acquire, at predetermined time intervals, the positional information for the second terminal apparatus 30 and transmit the acquired positional information for the second terminal apparatus 30, together with the user ID, to the information processing apparatus 40. The predetermined time intervals may be freely set but may also, for example, be based on the average speed at which the second terminal apparatus 30 moves.

In the present embodiment, the controller 36 transmits a first notification or a second notification to the information processing apparatus 40 via the communication interface 31 and the network 50.

<Configuration of Information Processing Apparatus>

As illustrated in FIG. 2, the information processing apparatus 40 includes a communication interface 41, a memory 42, and a controller 43.

The communication interface 41 includes at least one interface for communication for connecting to the network 50. The interface for communication may be compliant with, for example, mobile communication standards, wired local area network (LAN) standards, or wireless LAN standards, but these examples are not limiting. The interface for communication may be compliant with any appropriate communication standards. In the present embodiment, the information processing apparatus 40 communicates with the vehicle 10, the first terminal apparatus 20, and the second terminal apparatus 30 via the communication interface 41 and the network 50.

The memory 42 includes one or more memories. The memories included in the memory 42 may each function as, for example, a main memory, an auxiliary memory, or a cache memory. The memory 42 stores any information to be used for operations of the information processing apparatus 40. For example, the memory 42 may store a system program, an application program, a database, map information, and the like. The information stored in the memory 42 may be updated with, for example, information acquired from the network 50 via the communication interface 41. The memory 42 stores any information obtained by operations of the information processing apparatus 40.

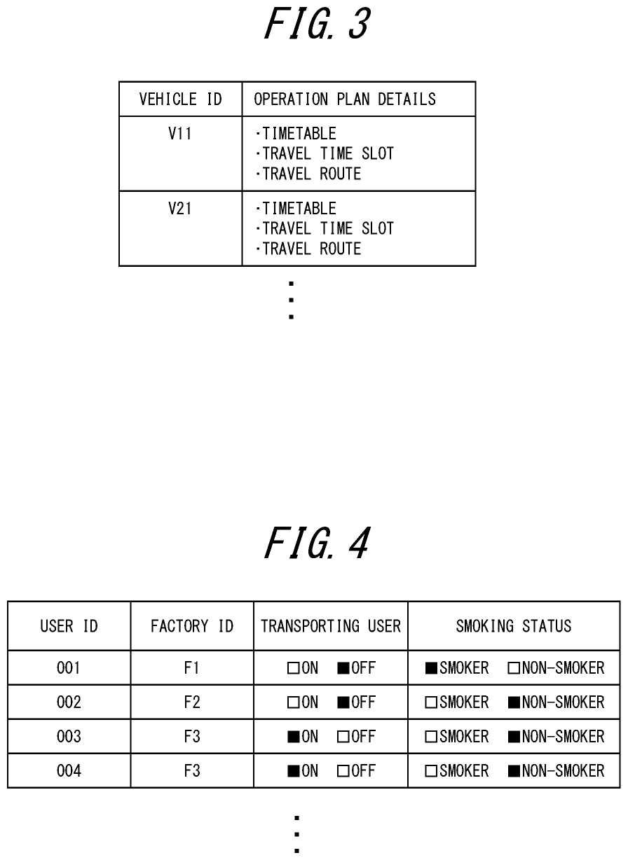

In the present embodiment, an operation plan such as the one illustrated in FIG. 3 is stored in the memory 42. The operation plan is information indicating an operation schedule for the vehicles 10. For example, the operation plan could include “vehicle IDs” and “operation plan details”.

The “vehicle ID” is any information that can uniquely identify the vehicle 10.

The “operation plan details” may include information on a timetable (operation schedule) in which the arrival and departure times for each stop are specified for each vehicle 10 identified by a vehicle ID, the travel time slot, and the travel route for the corresponding time slot. However, the information included in the operation plan is not limited to these examples. For example, the operation plan may include information on a time slot during which the vehicle 10 cannot be used for cargo/passenger mixing for reasons such as maintenance or recharging, information on time slots when no article 3 is scheduled to be loaded onto the vehicle 10, positional information for the vehicle 10 when not in use for cargo/passenger mixing, and the like.

A “user database”, such as the one illustrated in FIG. 4, is also stored in the memory 42. For example, the user database could include “user IDs”, “factory IDs”, “transporting users”, and “smoking status”.

The “user ID” is any information that can uniquely identify each user of the vehicle 10 (here, a worker who works in a factory within the site).

The “factory ID” is any information that can uniquely identify the factory where the user identified by the “user ID” works.

The “transporting user” is any information that indicates whether the user identified by the “user ID” is designated as a transporting user. In the example illustrated in FIG. 4, a flag is used to indicate whether the user is a transporting user. For example, “ON” indicates that the user is designated as a transporting user, and “OFF” indicates that the user is not designated as a transporting user. The transporting user flag is set to “ON” for the users with user IDs “003” and “004” to indicate that they are transporting users.

The “smoking status” is any information indicating whether each user is a smoker. In the example illustrated in FIG. 4, a flag is used to indicate the smoking status. For example, a smoking flag is set for the user with user ID

“001” to indicate that the user is a smoker. A non-smoking flag is set for the users with user IDs “002” and “003” to indicate that these users are non-smokers. Any method can be used to ascertain the smoking status of each user. For example, the smoking status of each user may be ascertained based on the results of a smoking questionnaire. The user database is not limited to this example and can include any data. For example, the user database may include any information indicating whether the user uses perfume, whether the user had a strong-smelling meal immediately beforehand, or the like. Whether the user uses perfume may be ascertained based on the results of a questionnaire, though this example is not limiting. Whether the user had a strong-smelling meal may be determined based on meal accounting information, though this example is not limiting.

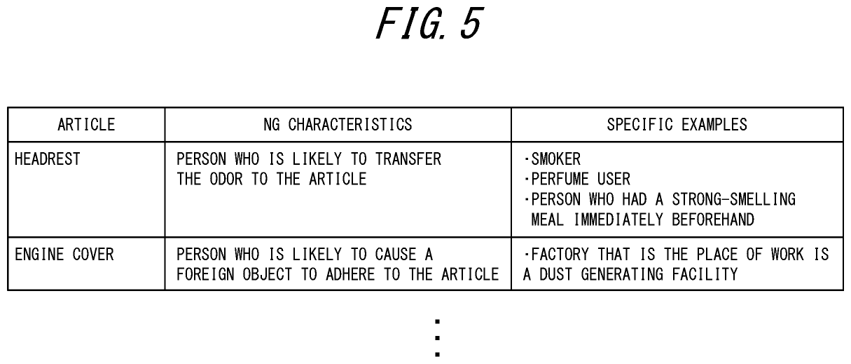

An article database, such as the one illustrated in FIG. 5, is also stored in the memory 42. The “article database” can include, for example, “articles”, “NG characteristics”, and “specific examples”.

The “article” is any information that uniquely identifies each article, including components produced at the factories within the site.

The “NG characteristics” are any information that indicates the characteristics of a person who can affect each article identified by the “article”. In the present embodiment, such characteristics are also referred to as “NG characteristics”. In the example illustrated in FIG. 5, the article “headrest” is a component that is in close contact with a person's head. The corresponding NG characteristic is therefore set to “person who is likely to transfer the odor to the article”. The article “engine cover” can adversely affect piston operation if a foreign object adheres to the engine cover. The corresponding NG characteristic is therefore set to “person who is likely to cause a foreign object to adhere to the article”.

“Specific examples” is any information indicating specific examples of NG characteristics. In the example illustrated in FIG. 5, “smoker”, “perfume user”, and “person who had a strong-smelling meal immediately beforehand” are set as specific examples of NG characteristics for the headrest. If a user to whom any of the specific examples is applicable rides concurrently in the vehicle 10 with the corresponding article (headrest), the likelihood that the user's odor will be transferred to the article, causing the quality of the product to deteriorate, increases as the distance to the article is less. “The factory that is the place of work is a dust generating facility” is set as a specific example of the NG characteristic for the engine cover. A dust generating facility is a facility in an environment where dust generated by operations such as welding, cutting, or crushing tends to adhere to the clothing or skin of workers or passersby. The longer the time of stay in such a facility, the greater the likelihood that dust will adhere to the clothing or skin of the user who is a worker or passerby. If a user to whom this specific example is applicable rides concurrently in the vehicle 10 with the corresponding article (engine cover), the likelihood that the dust adhered to the clothing or skin of the user will be transferred to the article, causing the quality of the product to deteriorate, increases as the distance to the article is less. Therefore, in the present embodiment, such a user can be identified as a user having a characteristic that can affect the article (NG user).

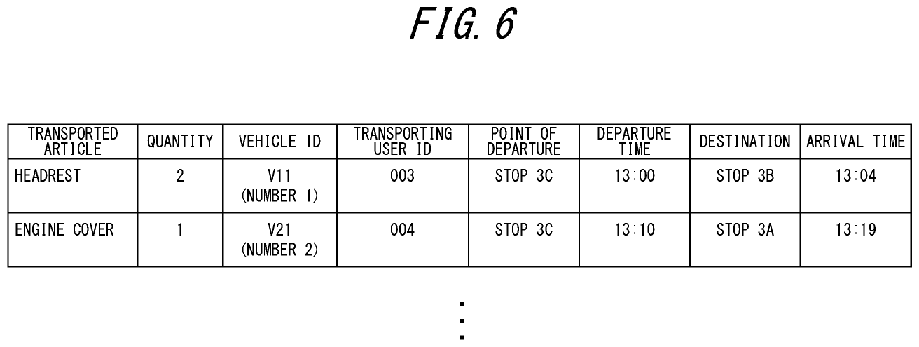

Article transportation information, such as the information illustrated in FIG. 6, is also stored in the memory 42. The “article transportation information” is information that indicates the transportation plan for an article. Information indicating the transportation plan for the article may be acquired by receiving request data, via the communication interface 41 and the network 50, from the second terminal apparatus 30 of the transporting user, a device of the administrator of the article, or an external server. The request data is data that requests that an item be loaded onto the vehicle 10 and transported. For example, the request data can include the “transported article”, “quantity”, “vehicle ID”, “transporting user ID”, “point of departure”, “departure time”, “destination”, and “arrival time”. The article transportation information may include not only current information but also past history information.

The “transported article” is any information that can uniquely identify the article to be loaded onto any transported by the vehicle 10, identified by the “vehicle ID” described below. In the example illustrated in FIG. 6, the “transported article” in the article transportation information is the same as the “article” in the article database described in FIG. 5, but this example is not limiting.

The “quantity” indicates the number of articles identified by the “transported article”.

The “vehicle ID” is any information that can uniquely identify the vehicle 10 on which the article is to be loaded. In the example illustrated in FIG. 6, the “vehicle ID” of the article transportation information is the same as the “vehicle ID” of the operation plan described in FIG. 3, but this example is not limiting.

The “transporting user ID” is any information that can uniquely identify the transporting user. In the example illustrated in FIG. 6, the “transporting user ID” in the article transportation information is the same as the “user ID” in the user database described in FIG. 4, but this example is not limiting.

The “point of departure” is any information that can uniquely identify the location where the article identified by the “transported article” is to be loaded onto the vehicle 10 identified by the “vehicle ID”. In the example illustrated in FIG. 6, stop 3C, which is included in the facility, is set as the “point of departure”.

The “departure time” is any information that indicates the time when the vehicle 10 identified by the “vehicle ID” in the article transportation information departs from the location identified by the “point of departure”.

The “destination” is any information that can uniquely identify the location where the article identified by the “transported article” is to be unloaded from the vehicle 10 identified by the “vehicle ID”. In the example illustrated in FIG. 6, stop 3B or stop 3A, which are included in the facility, is set as the “destination”.

The “arrival time” is any information that indicates the time when the vehicle 10 identified by the “vehicle ID” in the article transportation information arrives at the location identified by the “destination”.

Although the above-described database is constructed in the memory 42 in the present embodiment, it may be constructed in an external storage and connected to the information processing apparatus 40.

The controller 43 includes at least one processor, at least one programmable circuit, at least one dedicated circuit, or a combination of these. The controller 43 controls operations of the entire information processing apparatus 40.

In the present embodiment, the controller 43 can manage the operation of the vehicle 10 by referring to the operation plan stored in the memory 42.

In the present embodiment, the controller 43 can identify which article, when, where, by whom (the transporting user), and onto/from which vehicle 10 the article is to be loaded/unloaded by referring to the article transportation information stored in the memory 42. In other words, the controller 43 can refer to the article transportation information to learn the transportation status of the article.

In the present embodiment, the controller 43 can retrieve NG characteristics for each article by searching a characteristics database stored in the memory 42 using the article as a search key.

In the present embodiment, the controller 43 receives a first

notification or a second notification from the second terminal apparatus 30 via the communication interface 41 and the network 50. The controller 43 may store the first notification or the second notification received via the communication interface 41 in the memory 42.

The functions of the information processing apparatus 40 may be implemented by a processor corresponding to the controller 43 executing a processing program according to the present embodiment. That is, the functions of the information processing apparatus 40 may be implemented by software. The processing program enables a computer to function as the information processing apparatus 40 by causing the computer to execute the operations of the information processing apparatus 40. That is, the computer functions as the information processing apparatus 40 by executing the operations of the information processing apparatus 40 in accordance with the processing program.

Some or all of the functions of the information processing apparatus 40 may be realized by a dedicated circuit corresponding to the controller 43. That is, some or all of the functions of the information processing apparatus 40 may be realized by hardware.

The controller 43 can receive positional information for the vehicle 10 from the vehicle 10 via the communication interface 41 and the network 50.

The controller 43 may control the memory 42 to store the received positional information for the vehicle 10 in association with the time of receipt. The controller 43 can receive, from the first terminal apparatus 20 via the network 50, positional information for the first terminal apparatus 20 and identification information for the user of the first terminal apparatus 20. The controller 43 may control the memory 42 to store the received positional information for the first terminal apparatus 20 and the identification information for the user of the first terminal apparatus 20 in association with the time of receipt. The controller 43 can receive, from the second terminal apparatus 30 via the network 50, positional information for the second terminal apparatus 30 and identification information for the user of the second terminal apparatus 30 (i.e., the transporting user). The controller 43 may control the memory 42 to store the received positional information for the second terminal apparatus 30 and the identification information for the user of the second terminal apparatus 30 (i.e., the identification information for the transporting user) in association with the time of receipt.

<Flow of Operations of Information Processing Apparatus>

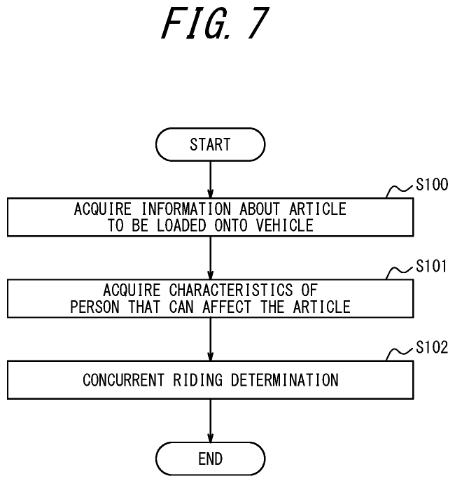

Operations of the information processing apparatus 40 according to the present embodiment will be described with reference to FIG. 7. The operations in FIG. 7 correspond to a method according to the present embodiment. The operations in FIG. 7 are executed repeatedly, for example, over a predetermined period. The predetermined period can be freely determined. For example, the operations in FIG. 7 may be executed each time the information processing apparatus 40 receives request data from the second terminal apparatus 30.

First, the preconditions for the operations in FIG. 7 are illustrated.

In the present embodiment, the vehicle 10 is a circulating bus that travels within a predetermined site. However, the vehicle 10 may travel anywhere other than the site. The vehicle 10 departs from a vehicle base according to a specified operation schedule and returns to the vehicle base after implementing mixed transportation of cargo and passengers while circulating along a predetermined route within the site. The route on which the vehicle 10 circulates includes stops 3A, 3B, and 3C, as illustrated in FIG. 1. Following the vehicle 10 that departed from the vehicle base (hereinafter also referred to as “vehicle 10 number 1”), another vehicle 10 (hereinafter also referred to as “vehicle 10 number 2”) departs from the vehicle base after a predetermined interval. Vehicle 10 number 2 corresponds to the subsequent vehicle in the present embodiment. The predetermined interval can be set freely, but here it is set to 10 minutes. In this case, a vehicle 10 arrives and departs once every 10 minutes at each stop within the site. According to the specified operation schedule, vehicle 10 number 2 returns to the vehicle base after implementing mixed transportation of cargo and passengers while circulating along the same route as vehicle 10 number 1.

The users who board and alight from the vehicle 10 are workers in a factory (e.g., an automobile manufacturing plant) within a site such as the one illustrated in FIG. 1. The users board and alight from the vehicle 10 at the stops. The users may use the vehicle 10 to travel between, for example, a railroad station and a factory within the site, or between factories. The users include users who carry the article 3 onto the vehicle 10, i.e., transporting users.

The article 3 is a factory-produced component (for example, seat material or exterior parts of an automobile), but this example is not limiting, and the article 3 can be any article (such as a tool).

There can be at least one factory within the site. In the present embodiment, a first factory F1, second factory F2, and third factory F3 are located in order from upstream to downstream along the production line, as illustrated in FIG. 1. Of these, the second factory F2 is assumed to be a dust generating facility. As illustrated in FIG. 1, the nearest stops to the first factory F1, the second factory F2, and the third factory F3 are stop 3A, stop 3B, and stop 3C, respectively. In the present embodiment, the vehicle 10 is assumed to circulate in the order of stop 3C, stop 3B, and stop 3A.

Under these conditions, a typical example of a situation that could arise is when one of the components delivered to the third factory F3 is found to be defective, and a request is issued to load the article onto a vehicle 10 and return the article to the upstream factory (for example, the second factory F2) to be reworked. In this case, the article in which the defect is found corresponds to the article in the present embodiment. During short-distance transportation between factories, articles are often transported on the seat or cargo rack in the vehicle 10 without bothering with packaging. In other words, articles can be transported in contact with the open air. Under such conditions, there is a risk of undesirable effects on the article from people (here, the users of the vehicle 10). In the present embodiment, the operations in FIG. 7 are executed in such a situation to help reduce the effects from people on the article.

The processing procedures for the operations in FIG. 7 are described below.

Step S100: the controller 43 of the information processing apparatus 40 acquires information about the article 3 to be loaded onto the vehicle 10.

Specifically, the controller 43 refers to the article transportation information to learn the transportation plan for the article. In the example illustrated in FIG. 6, the controller 43 refers to the article transportation information to identify that at 13:00 at stop 3C, two headrests as an article 3 are to be loaded by the transporting user with transporting user ID “003” (hereinafter also referred to as “transporting user X”) onto the vehicle 10 with vehicle ID “V11” (vehicle 10 number 1). The controller 43 also refers to the article transportation information to identify that two headrests as an article 3 are to be unloaded from vehicle 10 number 1 at stop 3B at or after 13:04 (for example, by the departure time 13:05).

Step S101: the controller 43 acquires the characteristics of the person that can affect the article 3 based on the information acquired in step S100.

Specifically, the controller 43 identifies the characteristics of the person that can affect the article 3 (NG characteristics) by searching the article database using the article 3 to be loaded onto the vehicle 10 identified in step S100 as a search key. In the example illustrated in FIG. 6, the controller 43 searches the article database illustrated in FIG. 5 using “headrest”, i.e., the article 3 to be loaded onto vehicle 10 number 1, as the search key. In this case, the NG characteristic of the headrest is identified as a “person who is likely to transfer the odor to the article”, a specific example of which is a “smoker” or the like. In this way, the controller 43 can acquire the characteristics of the person that can affect the article 3 based on the information acquired in step S100.

Step S102: the controller 43 executes the concurrent riding determination. In the concurrent riding determination, the existence of concurrent riding on the vehicle 10 by the article 3 and a user (NG user) having the characteristic (NG characteristic) acquired in step S101 is determined. The process then ends.

Specifically, at time T1, the controller 43 identifies the vehicle 10 onto which the article 3 has been loaded or is scheduled to be loaded by referring to the article transportation information. In the example illustrated in FIG. 6, in a case in which time T1 is later than 13:00, the transporting user X is on board the vehicle 10 (vehicle 10 number 1) with the article 3 at time T1. In other words, the article 3 has already been loaded onto vehicle 10 number 1. In this case, the controller 43 identifies vehicle 10 number 1 as the vehicle 10 onto which the article 3 has been loaded. On the other hand, in a case in which time T1 is before 13:00, the transporting user X is waiting at stop 3C in front of vehicle 10 number 1 at time T1. In other words, the article 3 has not yet been loaded onto vehicle 10 number 1. In this case, the controller 43 identifies vehicle 10 number 1 as the vehicle 10 onto which the article 3 is scheduled to be loaded. This process is also referred to below as “vehicle identification”.

The controller 43 refers to the positional information for the vehicle 10 received from the vehicle 10 identified by the vehicle identification, the positional information for the first terminal apparatus 20 received from the first terminal apparatus 20, and the positional information for the second terminal apparatus 30 received from the second terminal apparatus 30. The position indicated by the positional information for the first terminal apparatus 20 is considered to be the position of the user carrying the first terminal apparatus 20, and the position indicated by the positional information for the second terminal apparatus 30 is considered to be the position of the transporting user carrying the second terminal apparatus 30. Based on each piece of positional information, the controller 43 extracts the users who are either on board the vehicle 10 or waiting at an upcoming stop of the vehicle 10. The controller 43 refers to the article database to identify the users, among the extracted users, who correspond to NG users (for example, who correspond to the “specific examples”) in relation to the article 3 that has been or is scheduled to be loaded onto the vehicle 10. In the example illustrated in FIG. 6, the controller 43 identifies users (for example, smokers) who correspond to NG users in relation to the headrests loaded onto vehicle 10 number 1. For example, the user with user ID “001” indicated as a smoker in the user database (hereinafter, “smoking user Y”) is identified as a user who corresponds to an NG user. This process is also referred to below as “NG user identification”.

In a case in which a user corresponding to an NG user is identified by the NG user identification, the controller 43 determines that there is concurrent riding by the article 3 and the NG user in the vehicle 10. Conversely, in a case in which a user corresponding to an NG user is not identified, the controller 43 determines that there is not concurrent riding by the article 3 and the NG user in the vehicle 10. In this way, the controller 43 executes the concurrent riding determination to determine the existence of concurrent riding on the vehicle 10 by the article 3 and the NG user.

As described above, the concurrent riding determination in the present embodiment is for determining not only whether concurrent riding is actually occurring, but also whether concurrent riding could occur in the future. Accordingly, “there is concurrent riding” refers not only to the case in which concurrent riding is actually occurring, but also to the case in which concurrent riding is expected to occur in the future. By thus executing the concurrent riding determination, the controller 43 determines the existence of concurrent riding on the vehicle 10 by the article 3 and the NG user.

For the transporting user, in a case in which it is determined that the article 3 has arrived at the destination based on the positional information for the second terminal apparatus 30 of the transporting user and the positional information for the vehicle 10, or in a case in which the second notification is received, the controller 43 executes the concurrent riding determination while considering the second terminal apparatus 30 of the transporting user to be the first terminal apparatus 20 of a user of the vehicle 10 instead of the transporting user. This reduces the hassle for a user who is no longer the transporting user yet receives a request notification for loading vehicle change (under the assumption that the transporting user is being notified) after the article 3 has arrived at the destination. The transmission and reception of predetermined notifications can thus be optimized more easily.

By the concurrent riding determination according to the present embodiment, it can be determined whether a user of the vehicle 10, including the transporting user, is an NG user, and if so, the existence of concurrent riding by the article 3 and the NG user can be determined. Therefore, it is easier to take measures or actions to reduce the effect of the NG user on the article 3, for example by presenting this fact to the user.

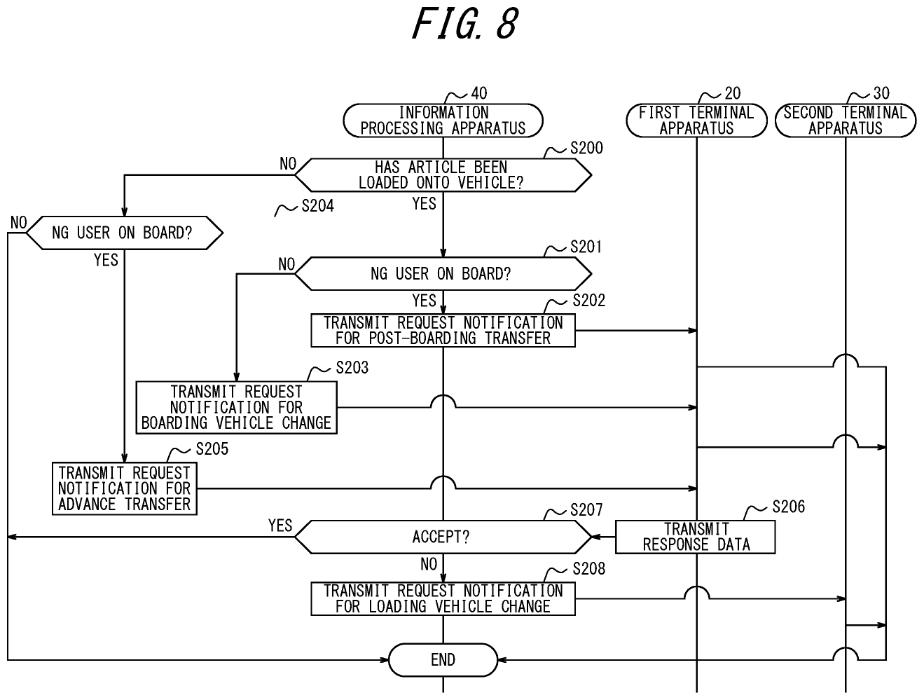

Furthermore, the controller 43 can further facilitate the taking of measures or actions to reduce the effect of a person (NG user) on the article 3 by presenting the users of the vehicle 10 with a predetermined notification (described below) regarding cargo/passenger mixing according to the result of the concurrent riding determination. The processing procedures for presenting a predetermined notification regarding cargo/passenger mixing are described below with reference to FIG. 8.

Step S200: the controller 43 of the information processing apparatus 40 determines whether the article 3 has been loaded onto the vehicle 10. In a case in which it is determined that the article 3 has been loaded onto the vehicle 10 (S200: Yes), the process advances to step S201. Conversely, in a case in which it is determined that the article 3 has not been loaded onto the vehicle 10 (S200: No), the process advances to step S204.

Specifically, the controller 43 refers to the article transportation information to identify the transporting user for each article indicated by the transported article. The controller 43 determines whether the article 3 has been loaded onto the vehicle 10 based on the positional information for the second terminal apparatus 30 carried by the identified transporting user and the positional information for the vehicle 10. For example, in a case in which it is determined that the second terminal apparatus 30 and the vehicle 10 are moving together, the controller 43 can determine that the article 3 has been loaded onto the vehicle 10. Alternatively, the controller 43 may determine that the article 3 has been loaded onto the vehicle 10 in a case in which it is determined that the first notification regarding the article 3 has been received from the second terminal apparatus 30 carried by the identified transporting user.

In the example illustrated in FIG. 6, the controller 43 identifies, for example, the transporting user (transporting user X) for the transported article “headrest” as the article 3. The controller 43 determines whether two headrests have been loaded onto the vehicle 10 based on the positional information for the second terminal apparatus 30 carried by the transporting user X and the positional information for vehicle 10 number 1. Alternatively, in a case in which it is determined that the first notification regarding two headrests has been received from the second terminal apparatus 30 carried by the transporting user X, the controller 43 may determine that two headrests have been loaded onto vehicle 10 number 1. Conversely, in a case in which it is determined that the first notification has not been received, the controller 43 can determine that two headrests have not been loaded onto the vehicle 10. The controller 43 may also determine whether the second notification regarding two headrests has been received from the second terminal apparatus 30 carried by the transporting user X. In a case in which it is determined that a second notification has been received, the article 3 has already been unloaded from vehicle 10. Therefore, the controller 43 can determine that the article 3 is not loaded onto the vehicle 10 in this case as well. Learning the latest status of cargo/passenger mixing based on the first notification and second notification makes it easier to respond to irregular situations when there is a deviation from the transportation plan indicated by the article transportation information, such as delays due to failure of the vehicle 10.

Step 201: in a case in which it is determined that the article 3 has been loaded onto the vehicle 10 (step S200: Yes), the controller 43 determines whether an NG user is on board the vehicle 10. In a case in which it is determined that an NG user is on board the vehicle 10 (S201: Yes), the process advances to step S202. Conversely, in a case in which it is determined that an NG user is not on board the vehicle 10 (S201: No), the process advances to step S203.

Specifically, the controller 43 identifies users who are NG users in relation to the article 3 by performing the NG user identification described above in step S102. The controller 43 determines whether the user identified as the NG user is on board the vehicle 10.

In the example illustrated in FIG. 6, the user with user ID “001” (smoking user Y) is identified as an NG user in relation to the headrest which is the article 3. In a case in which it is determined that the smoking user Y is on board the vehicle 10 (vehicle 10 number 1), the controller 43 determines that an NG user is on board the vehicle 10.

Whether the NG user is on board the vehicle 10 is determined, in the present embodiment, based on the positional information for the vehicle 10 and the positional information for the first terminal apparatus 20 carried by the NG user. However, any method can be used to determine whether the NG user is on board the vehicle 10. For example, the controller 43 may determine whether the NG user is on board the vehicle 10 by acquiring information from a sensor (such as a payment machine) installed at the entrance to the vehicle 10 and monitoring the boarding and alighting status.

Step S202: in a case in which it is determined that an NG user is on board the vehicle 10 (step S201: Yes), the controller 43 transmits a request notification for post-boarding transfer to the first terminal apparatus 20 of the NG user that is on board the vehicle 10. The controller 43 can present the request notification for post-boarding transfer to the NG user by having the first terminal apparatus 20 output the request notification for post-boarding transfer. The process then ends. The “request notification for post-boarding transfer” is a notification requesting one or more users, with an NG characteristic, who are on board the vehicle 10 with the article 3 to alight from the vehicle 10 and transfer to a subsequent vehicle (another vehicle 10) after the vehicle 10.

In other words, in a case in which, as a result of the concurrent riding determination, it is determined that the article 3 has been loaded onto the vehicle 10 (step S200: Yes) and one or more users with an NG characteristic are on board the vehicle 10 (step S201: Yes), the controller 43 transmits, via the communication interface 41, a request notification for post-boarding transfer to the first terminal apparatus 20 of the one or more users.

The “one or more users with an NG characteristic” referred to here are typically one or more users who are not normally NG users and thus are not extracted as NG users, but whose behavior during a predetermined period prior to boarding has resulted in their becoming NG users. These one or more users might not be extracted as NG users by matching with reference to the article database and the user database and might unexpectedly ride in the vehicle 10 concurrently with articles on which the users can have an undesirable effect. Hereafter, such users are also referred to as “gray users”.

In the present embodiment, gray users may be identified as NG users in the NG user identification described above in step S102. In other words, the controller 43 may execute the concurrent riding determination while considering a user without an NG characteristic as a user with an NG characteristic. Any method can be used to consider a user without an NG characteristic as a user with an NG characteristic. For example, the controller 43 may execute the concurrent riding determination while considering a user without an NG characteristic as a user with an NG characteristic when the user without an NG characteristics stays in a predetermined area for a predetermined period of time or longer. The predetermined area can include any location. As a first example, the predetermined area includes a smoking area within the site. In this case, if user A, a non-smoker, stays in a smoking area near the stop for a predetermined period of time (such as 5 minutes) just before boarding, for example, user A could be considered an NG user in relation to the article. In the example illustrated in FIG. 4, user A can be the user with user ID “002”, “003”, or “004”. As a second example, the predetermined area includes a dust generating facility within the site. In this case, if user B, who works at the first factory F1 or the third factory F3, stays at the second factory F2, which is a dust generating facility, for a predetermined period of time (such as one hour) before boarding, for example, user B could be considered an NG user in relation to the article. In the example illustrated in FIG. 4, user B can be the user with user ID “001”, “003”, or “004”. Hereafter, users such as user A or user B are also referred to as “gray users”.

In this step (S202), typically a gray user is identified, and a request notification for post-boarding transfer is transmitted to the first terminal apparatus 20 of the gray user. Any method can be used to identify the gray user. For example, the controller 43 can receive, from the communication interface 11 of the vehicle 10 via the communication interface 11 and the network 50, data as vehicle interior information indicating the strength of an odor, the amount of dust, or the like in the vehicle 10 as acquired through the detector 13 installed in the ceiling, seat, or other location in the vehicle 10. Based on the received vehicle interior information, the controller 43 can observe data indicating the strength of the odor, the amount of dust, or the like emitted by each user on board the vehicle 10. The controller 43 can identify users with an NG characteristic in relation to the article as gray users based on observed data. For example, a user identified as the source of an odor at or above a predetermined level can be identified as a gray user.

In the example illustrated in FIG. 6, a notification is transmitted, as a request notification for post-boarding transfer, to the first terminal apparatus 20 of a gray user on board the vehicle 10 (here, vehicle 10 number 1), requesting transfer to the vehicle 10 with vehicle ID “V21” (hereinafter also referred to as “vehicle 10 number 2”), which is the subsequent vehicle after vehicle 10 number 1.

At this time, the controller 43 may present to the gray user the waiting time estimated in the case of the gray user alighting from vehicle 10 number 1 and transferring to vehicle 10 number 2 (hereinafter also referred to as “estimated waiting time”). Any method can be used to present the estimated waiting time. For example, the controller 43 may determine whether each vehicle 10 is operating according to its operation schedule by determining whether the first vehicle 10 and the second vehicle 10 are delayed based on factors such as the average speed of each vehicle 10. Based on the results of the determination, the controller 43 may calculate the waiting time at an upcoming stop of vehicle 10 number 1 (in this case, the next stop) from the scheduled arrival and departure time of each vehicle 10. If no vehicle 10 is delayed, the estimated waiting time can be calculated to be 10 minutes, as per the operation schedule. The controller 43 may transmit and output the calculated waiting time as the estimated waiting time to the first terminal apparatus 20 of the gray user via the network 50. The estimated waiting time can thereby be presented (notified) to the gray user in the case of alighting from vehicle 10 number 1 and transferring to vehicle 10 number 2. As a result, it is easier in particular to get gray users who correspond to an NG user to consider transferring to another vehicle 10.

In other words, as a general rule in the present embodiment, precautionary measures are taken to avoid a situation in which an NG user and an article concurrently ride, but when concurrent riding occurs by exception, the processing in this step (S202) can be executed for an “after-the-fact” response. According to the present step, gray users who are likely to be NG users are considered as NG users in addition to the case in which a user is identified as an NG user. NG users can thereby be identified without omission. If a gray user is actually an NG user in relation to the article, concurring riding occurs between the article and the NG user. In this case, presentation of the request notification for post-boarding transfer according to the present step can encourage the gray user to transfer to a different vehicle 10. It is consequently easier to eliminate concurrent riding by the article and the NG user.

Step S203: in a case in which it is determined that an NG user is not on board the vehicle 10 (step S201: No), the controller 43 transmits a request notification for boarding vehicle change to the first terminal apparatus 20 carried by an NG user waiting at an upcoming stop of the vehicle 10. The process then ends. A “request notification for boarding vehicle change” is a notification requesting to forgo boarding the vehicle 10 and to board a subsequent vehicle after the vehicle 10. The vehicle 10 here is typically the next vehicle 10 to arrive at the stop where the NG user is waiting.

In other words, in a case in which, as a result of the concurrent riding determination, it is determined that the article 3 has been loaded onto the vehicle 10 and an NG user is waiting at an upcoming stop of the vehicle 10, the controller 43 transmits a request notification for boarding vehicle change to the first terminal apparatus 20 of the NG user via the communication interface 41.

Specifically, the controller 43 determines whether an NG user is waiting at an upcoming stop of the vehicle 10, and determines whether to transmit the request notification for boarding vehicle change according to the result of the determination. In a case in which it is determined that an NG user is waiting at an upcoming stop of the vehicle 10, the controller 43 transmits the request notification for boarding vehicle change to the first terminal apparatus 20 carried by the NG user waiting at the upcoming stop of the vehicle 10.

In the example illustrated in FIG. 6, in a case in which it is determined that an NG user is waiting at an upcoming stop of the vehicle 10 (vehicle 10 number 1), for example at a stop between stop 3C and stop 3B (hereinafter also referred to as “stop 3M”), the controller 43 transmits a request notification for boarding vehicle change to the first terminal apparatus 20 carried by the NG user waiting at stop 3M.

The controller 43 then transmits the request notification for boarding vehicle change to the first terminal apparatus 20 of the NG user and causes the notification to be outputted, thereby making it easier for the NG user to consider forgoing boarding the vehicle 10 and to board a subsequent vehicle after the vehicle 10.

Any method can be used to determine whether the NG user is waiting at an upcoming stop of the vehicle 10. For example, the controller 43 may determine whether the NG user is waiting at an upcoming stop of the vehicle 10 based on the positional information for the first terminal apparatus 20 carried by the NG user.

Step 204: in a case in which it is determined that the article 3 has not been loaded onto the vehicle 10 (step S200: No), the controller 43 determines whether an NG user is on board the vehicle 10. In a case in which it is determined that an NG user is on board the vehicle 10 (S204: Yes), the process advances to step S205. Conversely, in a case in which it is determined that an NG user is not on board the vehicle 10 (S204: No), the process ends. The method for determining whether the NG user is on board the vehicle 10 is the same as that described above in step S201. Hence, an explanation is omitted.

Step S205: in a case in which it is determined that an NG user is on board the vehicle 10 (step S204: Yes), the controller 43 transmits a request notification for advance transfer to the first terminal apparatus 20 of the NG user that is on board the vehicle 10. The controller 43 can present the request notification for advance transfer to the NG user by having the first terminal apparatus 20 output the request notification for advance transfer. The “request notification for advance transfer” is a notification requesting the NG user on board the vehicle 10 to alight from the vehicle 10 before the article 3 is loaded onto the vehicle 10 and to transfer to a subsequent vehicle (another vehicle 10) after the vehicle 10.

In other words, in a case in which, as a result of the concurrent riding determination, it is determined that the article 3 is scheduled to be loaded onto the vehicle 10 and an NG user is on board the vehicle 10, the controller 43 transmits a request notification for advance transfer to the first terminal apparatus 20 of the NG user via the communication interface 41.

In the example illustrated in FIG. 6, a notification requesting transfer to vehicle 10 number 2 is transmitted, as a request notification for advance transfer, to the first terminal apparatus 20 of the gray user on board vehicle 10 number 1.

At this time, the controller 43 may present to the NG user the estimated waiting time in the case of alighting from vehicle 10 number 1 and transferring to vehicle 10 number 2, as in step S202, described above. As a result, it is easier to get the NG user to consider transferring to another vehicle 10.

Step S206: the controller 26 of the first terminal apparatus 20 transmits response data to the information processing apparatus 40.

Specifically, the NG user on board the vehicle 10 operates the first terminal apparatus 20 to input the result of considering whether to accept the request indicated in the request notification for advance transfer.

In the example illustrated in FIG. 6, the NG user operates the first terminal apparatus 20 to input the result of considering whether to accept the request to alight from vehicle 10 number 1 at the next stop (stop M), for example, before the headrests are loaded onto vehicle 10 number 1 and transfer to vehicle 10 number 2.

Any method can be used to input the result of consideration. For example, selection buttons (for example, accept and reject buttons) along with a pop-up asking whether to accept or reject the request may be displayed on a screen as the output interface 24 of the NG user's first terminal apparatus 20, and the NG user may tap a button to input the result of consideration.

The controller 26 of the first terminal apparatus 20 then transmits the inputted result of consideration as response data to the communication interface 41 of the information processing apparatus 40 via the communication interface 21 and the network 50.

Step S207: the controller 43 of the information processing apparatus 40 determines whether the request indicated in the request notification for advance transfer has been accepted. In a case in which it is determined that the request has been accepted, the process ends. Conversely, in a case in which it is determined that the request has been rejected, the process advances to step S208.

Specifically, the controller 43 refers to the response data received from the first terminal apparatus 20 of the NG user to determine whether the request indicated in the request notification for advance transfer has been accepted by the NG user on board the vehicle 10. In a case in which the result of consideration by the NG user indicated by the response data indicates acceptance of the request, the controller 43 determines that the request has been accepted. Conversely, in a case in which the result of consideration by the NG user indicated by the response data indicates rejection of the request, the controller 43 determines that the request has been rejected.

Step S208: the controller 43 transmits a request notification for loading vehicle change to the second terminal apparatus 30 of the transporting user who loads the article 3 onto the vehicle 10. The controller 43 can present the request notification for loading vehicle change to the transporting user by having the second terminal apparatus 30 output the request notification for loading vehicle change. The process then ends. The “request notification for loading vehicle change” is a notification requesting that the article 3 be loaded onto a subsequent vehicle after the vehicle 10. A typical example of when the processing in this step occurs is when the request indicated in the request notification for advance transfer is rejected by the NG user.

In other words, in a case in which, as a result of the concurrent riding determination, it is determined that the article 3 is scheduled to be loaded onto the vehicle 10 and an NG user is on board the vehicle 10, the controller 43 transmits, via the communication interface 41, a request notification for loading vehicle change to the second terminal apparatus 30 of the transporting user who is to load the article 3 onto the vehicle 10.

In the example illustrated in FIG. 6, the controller 43 transmits a request notification for loading vehicle change regarding the headrests to the second terminal apparatus 30 of the transporting user X, who is waiting at stop 3C to load the headrests onto vehicle 10 number 1, to cause the second terminal apparatus 30 to output and present the request notification for loading vehicle change to the transporting user X. This enables the transporting user X, who is waiting at stop 3C, to consider, before loading the headrests onto vehicle 10 number 1, whether to load the headrests onto vehicle 10 number 2, for example, instead of vehicle 10 number 1.

This encourages the transporting user to change the loading vehicle and facilitates taking precautionary measures to avoid concurrent riding by the article and the NG user.

For the sake of explanation, step S208 is described as if it were executed after steps S205 through S207, but steps S205 through S207 and step S208 may be executed in reverse order. In other words, after the request notification for loading vehicle change is presented to the transporting user, the request notification for advance transfer may be presented to the NG user on board the vehicle 10.

The controller 43 repeats the above-described process for the remaining articles included in the article transportation information (such as the engine cover in the example in FIG. 6). This encourages precautionary measures, to avoid concurrent riding by each article and an NG user, or an after-the-fact response, thereby facilitating loading of each article onto an appropriate vehicle 10 and transportation to the destination.

As described above, the information processing apparatus 40

according to the present embodiment acquires information about the article 3 to be loaded onto the vehicle 10. The information processing apparatus 40 acquires a characteristic (NG characteristic) of a person who can affect the article 3 based on the information. The information processing apparatus 40 executes a concurrent riding determination to determine the existence of concurrent riding on the vehicle 10 by the article 3 and a user having the NG characteristic (NG user).

According to this configuration, it is determined by the concurrent riding determination whether a user of the vehicle 10, including the transporting user, corresponds to a user having a characteristic of a person who can affect the article that has been loaded, or is scheduled to be loaded, onto the vehicle 10. Therefore, it is easier to take measures or actions to reduce the effect of the NG user on the article, for example by presenting this fact to the user. Technology related to cargo/passenger mixing is therefore improved in that the effect on the article from passengers is more easily reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 40 in the above embodiment are distributed to multiple computers capable of communicating with each other can be implemented. For example, an embodiment in which some or all of the components of the information processing apparatus 40 are provided in the vehicle 10, the first terminal apparatus 20, or the second terminal apparatus 30 can also be implemented.

For example, an embodiment in which a general purpose computer functions as the information processing apparatus 40 according to the above embodiment can also be implemented. Specifically, a program in which processes for realizing the functions of the information processing apparatus 40 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] An information processing apparatus comprising a controller configured to:

acquire information about an article to be loaded onto a vehicle;

acquire a characteristic of a person who can affect the article based on the information; and

execute a concurrent riding determination to determine existence of concurrent riding on the vehicle by the article and a user having the characteristic.

[Appendix 2] The information processing apparatus according to appendix 1, further comprising a communication interface, wherein

in a case in which it is determined as a result of the concurrent riding determination that the article has been loaded onto the vehicle and the user is waiting at an upcoming stop of the vehicle, the controller is configured to transmit, via the communication interface to a terminal apparatus of the user, a request notification for boarding vehicle change requesting to forgo boarding the vehicle and to board a subsequent vehicle after the vehicle.

[Appendix 3] The information processing apparatus according to appendix 1 or 2, further comprising a communication interface, wherein

in a case in which it is determined as a result of the concurrent riding determination that the article is scheduled to be loaded onto the vehicle and the user is on board the vehicle, the controller is configured to transmit, via the communication interface to a terminal apparatus of the user, a request notification for advance transfer requesting to alight from the vehicle and to transfer to a subsequent vehicle after the vehicle.

[Appendix 4] The information processing apparatus according to appendix 1 or 2, further comprising a communication interface, wherein

in a case in which it is determined as a result of the concurrent riding determination that the article is scheduled to be loaded onto the vehicle and the user is on board the vehicle, the controller is configured to transmit, via the communication interface to a terminal apparatus of a transporting user who is to load the article onto the vehicle, a request notification for loading vehicle change requesting to load the article onto a subsequent vehicle after the vehicle.

[Appendix 5] The information processing apparatus according to appendix 4, wherein in a case in which it is determined that the article has arrived at a destination based on positional information of the terminal apparatus of the transporting user and positional information of the vehicle, or in a case in which a notification reporting that the article has been delivered to a delivery destination is received from the terminal apparatus of the transporting user, the controller is configured to execute the concurrent riding determination while considering the terminal apparatus of the transporting user to be a terminal apparatus of a user of the vehicle instead of the transporting user.
[Appendix 6] The information processing apparatus according to any one of appendices 1 to 5, further comprising a communication interface, wherein

in a case in which it is determined as a result of the concurrent riding determination that the article has been loaded onto the vehicle and one or more users having the characteristic is on board the vehicle, the controller is configured to transmit, via the communication interface to a terminal apparatus of the one or more users, a request notification for post-boarding transfer requesting to alight from the vehicle and to transfer to a subsequent vehicle after the vehicle.

[Appendix 7] The information processing apparatus according to any one of appendices 1 to 6, wherein the vehicle is a circulating bus traveling within a site that includes a factory.
[Appendix 8] The information processing apparatus according to appendix 7, wherein when a user not having the characteristic stays in a predetermined area for a predetermined period of time or longer, the controller is configured to execute the concurrent riding determination while considering the user not having the characteristic to be a user having the characteristic.
[Appendix 9] The information processing apparatus according to appendix 8, wherein the predetermined area includes a smoking area within the site.
[Appendix 10] The information processing apparatus according to appendix 8 or 9, wherein the predetermined area includes a dust generating facility within the site.
[Appendix 11] A method to be executed by an information processing apparatus, the method comprising:

acquiring information about an article to be loaded onto a vehicle;

acquiring a characteristic of a person who can affect the article based on the information; and

executing a concurrent riding determination to determine existence of concurrent riding on the vehicle by the article and a user having the characteristic.

[Appendix 12] The method according to appendix 11, further comprising transmitting to a terminal apparatus of the user, in a case in which it is determined as a result of the concurrent riding determination that the article has been loaded onto the vehicle and the user is waiting at an upcoming stop of the vehicle, a request notification for boarding vehicle change requesting to forgo boarding the vehicle and to board a subsequent vehicle after the vehicle.
[Appendix 13] The method according to appendix 11 or 12, further comprising transmitting to a terminal apparatus of the user, in a case in which it is determined as a result of the concurrent riding determination that the article is scheduled to be loaded onto the vehicle and the user is on board the vehicle, a request notification for advance transfer requesting to alight from the vehicle and to transfer to a subsequent vehicle after the vehicle.
[Appendix 14] The method according to appendix 11 or 12, further comprising transmitting to a terminal apparatus of a transporting user who is to load the article onto the vehicle, in a case in which it is determined as a result of the concurrent riding determination that the article is scheduled to be loaded onto the vehicle and the user is on board the vehicle, a request notification for loading vehicle change requesting to load the article onto a subsequent vehicle after the vehicle.
[Appendix 15] The method according to appendix 14, further comprising executing the concurrent riding determination while considering, in a case in which it is determined that the article has arrived at a destination based on positional information of the terminal apparatus of the transporting user and positional information of the vehicle, or in a case in which a notification reporting that the article has been delivered to a delivery destination is received from the terminal apparatus of the transporting user, the terminal apparatus of the transporting user to be a terminal apparatus of a user of the vehicle instead of the transporting user.
[Appendix 16] The method according to any one of appendices 11 to 15, further comprising transmitting, in a case in which it is determined as a result of the concurrent riding determination that the article has been loaded onto the vehicle and one or more users having the characteristic is on board the vehicle, a request notification for post-boarding transfer, to a terminal apparatus of the one or more users, requesting to alight from the vehicle and to transfer to a subsequent vehicle after the vehicle.
[Appendix 17] The method according to any one of appendices 11 to 16, wherein the vehicle is a circulating bus traveling within a site that includes a factory.
[Appendix 18] The method according to appendix 17, further comprising executing the concurrent riding determination while considering, when a user not having the characteristic stays in a predetermined area for a predetermined period of time or longer, the user not having the characteristic to be a user having the characteristic.
[Appendix 19] The method according to appendix 18, wherein the predetermined area includes a smoking area within the site.
[Appendix 20] The method according to appendix 18 or 19, wherein the predetermined area includes a dust generating facility within the site.

1. An information processing apparatus comprising a controller configured to:
acquire information about an article to be loaded onto a vehicle;
acquire a characteristic of a person who can affect the article based on the information; and
execute a concurrent riding determination to determine existence of concurrent riding on the vehicle by the article and a user having the characteristic.

2. The information processing apparatus according to claim 1, further comprising a communication interface, wherein
in a case in which it is determined as a result of the concurrent riding determination that the article has been loaded onto the vehicle and the user is waiting at an upcoming stop of the vehicle, the controller is configured to transmit, via the communication interface to a terminal apparatus of the user, a request notification for boarding vehicle change requesting to forgo boarding the vehicle and to board a subsequent vehicle after the vehicle.

3. The information processing apparatus according to claim 1, further comprising a communication interface, wherein
in a case in which it is determined as a result of the concurrent riding determination that the article is scheduled to be loaded onto the vehicle and the user is on board the vehicle, the controller is configured to transmit, via the communication interface to a terminal apparatus of the user, a request notification for advance transfer requesting to alight from the vehicle and to transfer to a subsequent vehicle after the vehicle.

4. The information processing apparatus according to claim 1, further comprising a communication interface, wherein
in a case in which it is determined as a result of the concurrent riding determination that the article is scheduled to be loaded onto the vehicle and the user is on board the vehicle, the controller is configured to transmit, via the communication interface to a terminal apparatus of a transporting user who is to load the article onto the vehicle, a request notification for loading vehicle change requesting to load the article onto a subsequent vehicle after the vehicle.

5. The information processing apparatus according to claim 4, wherein in a case in which it is determined that the article has arrived at a destination based on positional information of the terminal apparatus of the transporting user and positional information of the vehicle, or in a case in which a notification reporting that the article has been delivered to a delivery destination is received from the terminal apparatus of the transporting user, the controller is configured to execute the concurrent riding determination while considering the terminal apparatus of the transporting user to be a terminal apparatus of a user of the vehicle instead of the transporting user.

6. The information processing apparatus according to claim 1, further comprising a communication interface, wherein
in a case in which it is determined as a result of the concurrent riding determination that the article has been loaded onto the vehicle and one or more users having the characteristic is on board the vehicle, the controller is configured to transmit, via the communication interface to a terminal apparatus of the one or more users, a request notification for post-boarding transfer requesting to alight from the vehicle and to transfer to a subsequent vehicle after the vehicle.

7. The information processing apparatus according to claim 1, wherein the vehicle is a circulating bus traveling within a site that includes a factory.

8. The information processing apparatus according to claim 7, wherein when a user not having the characteristic stays in a predetermined area for a predetermined period of time or longer, the controller is configured to execute the concurrent riding determination while considering the user not having the characteristic to be a user having the characteristic.

9. The information processing apparatus according to claim 8, wherein the predetermined area includes a smoking area within the site.

10. The information processing apparatus according to claim 8, wherein the predetermined area includes a dust generating facility within the site.

11. A method to be executed by an information processing apparatus, the method comprising:
acquiring information about an article to be loaded onto a vehicle;
acquiring a characteristic of a person who can affect the article based on the information; and
executing a concurrent riding determination to determine existence of concurrent riding on the vehicle by the article and a user having the characteristic.

12. The method according to claim 11, further comprising transmitting to a terminal apparatus of the user, in a case in which it is determined as a result of the concurrent riding determination that the article has been loaded onto the vehicle and the user is waiting at an upcoming stop of the vehicle, a request notification for boarding vehicle change requesting to forgo boarding the vehicle and to board a subsequent vehicle after the vehicle.

13. The method according to claim 11, further comprising transmitting to a terminal apparatus of the user, in a case in which it is determined as a result of the concurrent riding determination that the article is scheduled to be loaded onto the vehicle and the user is on board the vehicle, a request notification for advance transfer requesting to alight from the vehicle and to transfer to a subsequent vehicle after the vehicle.

14. The method according to claim 11, further comprising transmitting to a terminal apparatus of a transporting user who is to load the article onto the vehicle, in a case in which it is determined as a result of the concurrent riding determination that the article is scheduled to be loaded onto the vehicle and the user is on board the vehicle, a request notification for loading vehicle change requesting to load the article onto a subsequent vehicle after the vehicle.

15. The method according to claim 14, further comprising executing the concurrent riding determination while considering, in a case in which it is determined that the article has arrived at a destination based on positional information of the terminal apparatus of the transporting user and positional information of the vehicle, or in a case in which a notification reporting that the article has been delivered to a delivery destination is received from the terminal apparatus of the transporting user, the terminal apparatus of the transporting user to be a terminal apparatus of a user of the vehicle instead of the transporting user.

16. The method according to claim 11, further comprising transmitting, in a case in which it is determined as a result of the concurrent riding determination that the article has been loaded onto the vehicle and one or more users having the characteristic is on board the vehicle, a request notification for post-boarding transfer, to a terminal apparatus of the one or more users, requesting to alight from the vehicle and to transfer to a subsequent vehicle after the vehicle.

17. The method according to claim 11, wherein the vehicle is a circulating bus traveling within a site that includes a factory.

18. The method according to claim 17, further comprising executing the concurrent riding determination while considering, when a user not having the characteristic stays in a predetermined area for a predetermined period of time or longer, the user not having the characteristic to be a user having the characteristic.

19. The method according to claim 18, wherein the predetermined area includes a smoking area within the site.

20. The method according to claim 18, wherein the predetermined area includes a dust generating facility within the site.
